(19) United States
(12) Patent Application Publication
(10) Pub. No.: US 2009/0282448 A1
(43) Pub. Date: Nov. 12, 2009

(54) SET TOP BOX AND PARAMETER SETTING METHOD

(75) Inventors: Deng-Rung Liu, Tu-Cheng (TW); Shih-Chun Wu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/206,728

(22) Filed: Sep. 8, 2008

(30) Foreign Application Priority Data
May 9, 2008 (CN) 200810301498.X

(51) Int. Cl. H04N 7/173; H04N 7/16; G06F 15/177

(52) U.S. Cl. 725/110; 725/152; 709/220; 709/222

(57) ABSTRACT

A set top box communicates with a plurality of configuration servers for obtaining setting parameters from the configuration servers. The set top box includes a configuration server list cache, a selecting module, an obtaining module, and a setting module. The configuration server list cache stores a list of internet protocol (IP) addresses of the plurality of configuration servers onto a memory system of the set top box. The selecting module selects one IP address from the list of the IP addresses. The obtaining module sends a parameter setting request to one configuration server corresponding to the selected IP address and obtaining a parameter setting message from said configuration server, wherein the one configuration server is selected from the plurality of configuration severs. The setting module sets the set top box according to the parameter setting message. A parameter setting method is also provided.

### BACKGROUND

1. Field of the Invention

The present disclosure relates to a cable TV system, and more particularly to a set top box and a parameter setting method.

2. Description of Related Art

Cable television systems are widely deployed for distributing television programs, typically providing more selection and better reception quality than that of traditional over-the-air broadcast systems. The deployment of new cable technology, such as digital cables, provides more robust transmission and increased channel capacity, thereby allowing additional services to be offered, such as selective subscription to premium channels and pay-per-view events. The offering of such services typically requires a set top box.

The set top box is an access equipment that should be configured prior to being connected with cable TV systems. Conventionally, operators manually configure parameters of the set top box. However, this method undoubtedly increases the operating cost.

### SUMMARY

One aspect of the present disclosure provides a set top box. The set top box communicates with a plurality of configuration servers for obtaining setting parameters from the configuration servers. The set top box includes a configuration server list cache, a selecting module, an obtaining module, and a setting module. The configuration server list cache stores a list of internet protocol (IP) addresses of the plurality of configuration servers onto a memory system of the set top box. The selecting module selects one IP address from the list of the IP addresses. The obtaining module sends a parameter setting request to one configuration server corresponding to the selected IP address and obtaining a parameter setting message from said configuration server, wherein the one configuration server is selected from the plurality of configuration severs. The setting module sets the set top box according to the parameter setting message.

Other objectives, advantages and novel features of the present disclosure will be drawn from the following detailed description of preferred embodiments of the present disclosure with the attached drawings, in which:

### BRIEF DESCRIPTION OF THE DRAWINGS

FIG. 1 is a schematic diagram illustrating an application environment of a set top box in accordance with one embodiment of the present disclosure;

FIG. 2 is a block diagram showing functional modules of the set top box of FIG. 1;

FIG. 3 is a table of a configuration server list cache of the present disclosure; and

FIG. 4 is a flowchart of a method for setting parameters of the set top box in accordance with an embodiment of the present disclosure.

### DETAILED DESCRIPTION OF CERTAIN INVENTIVE EMBODIMENTS

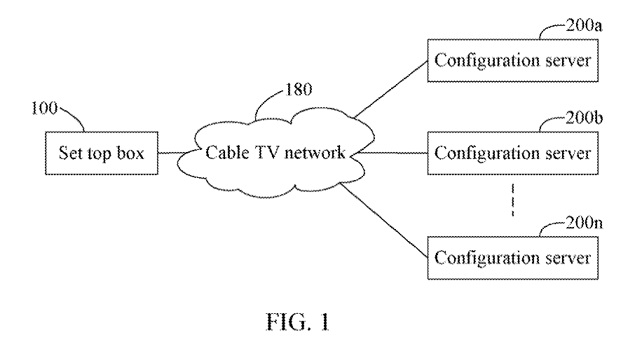

FIG. 1 is a schematic diagram illustrating an application environment of a set top box 100 in accordance with one embodiment of the disclosure.

In one embodiment, the set top box 100 communicates with one or more configuration servers 200 through a cable TV network 180. Each of the configuration servers 200 can provide parameters and TV services for the set top box 100. The set top box 100 selects the configuration server 200, such as a configuration server 200a as a default server when the set top box 100 is configured for communicating with a cable TV system for a first time.

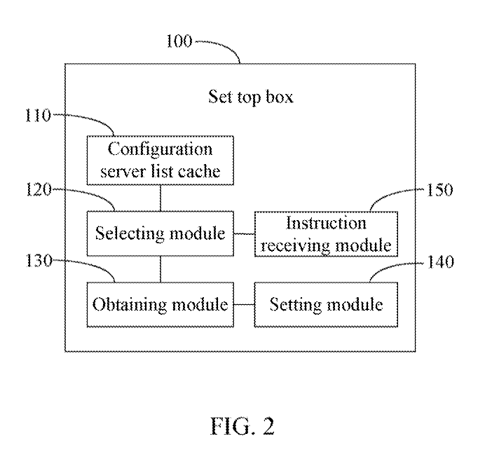

FIG. 2 is a block diagram showing functional modules of the set top box 100 of FIG. 1. In one embodiment, the set top box 100 includes a configuration server list cache 110, a selecting module 120, an obtaining module 130, and a setting module 140. The modules 110, 120, 130, 140 may be used to execute one or more operations for the set top box 100 in order to configure the set top box for communication with the cable TV system.

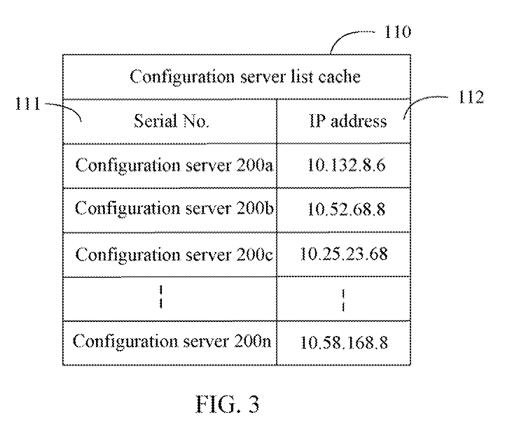

The configuration server list cache 110 stores and includes internet protocol (IP) addresses of the configuration servers 200. In one embodiment, the configuration server list cache 110 may comprise data that may be formatted to include two columns. One column records serial numbers of the configuration servers 200, while the other column records the corresponding IP addresses of the configuration servers 200. The configuration server list cache 110, in one embodiment, may store the data onto a hard disk drive, a flash memory, a compact disc (CD), or a random access memory, for example, of the set top box 100. Further details of the configuration cache list will be described with respect to FIG. 3 below.

The selecting module 120 selects the IP address of the default configuration server 200 to communicate with when the set top box 100 is turned on and configured for the first time. The selecting module 120 sends a connecting request to the selected configuration server 200 with the selected IP address. The selecting module 120 determines if the default configuration server 200 can be successfully connected if an acknowledgement message has been received from the default configuration server 200.

The obtaining module 130 sends a parameter setting request to the selected configuration server 200 with the selected IP address and receives a parameter setting message from the selected configuration server 200. The selecting module 120 selects another IP address from the configuration server list cache 110 if the set top box 100 does not receive an acknowledgement message from the default configuration server 200.

The setting module 140 sets the set top box 100 according to the parameter setting request.

In alternative embodiments, the set top box 100 may further include an instruction receiving module 150. The instruction receiving module 150 receives instructions produced by user including a power on instruction, a power off instruction, and a tuning instruction, among other instructions.

FIG. 3 is a table of a configuration server list cache 110 according to one embodiment of the present disclosure. In one embodiment, the configuration server list cache 110 includes a serial number column 111 and an IP address column 112. The serial number column 111 records the serial numbers of the configuration servers 200. The IP address column 112 records the corresponding IP addresses of the configuration servers 200.

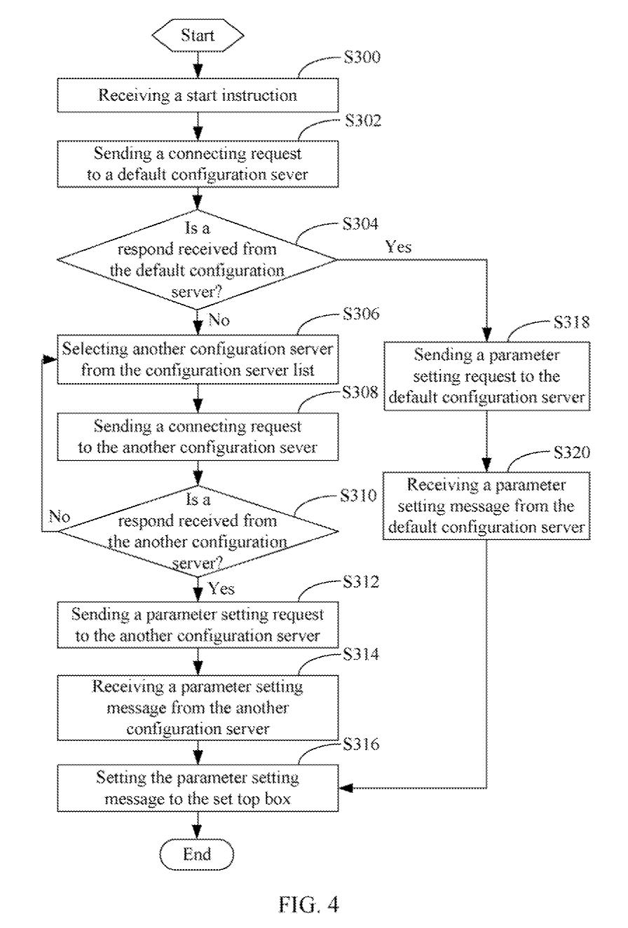

FIG. 4 is a flowchart of one embodiment of a method for setting parameters of the set top box 100 in accordance with the present disclosure. The method of FIG. 4 may be used to initially configure the set top box 100 to communicate with one or more of the configuration servers 200 though the cable TV network 180. Depending on the embodiment, additional blocks may be added, others deleted, and the ordering of the blocks may be changed.

In block S300, the instruction receiving module 150 receives a power on instruction sent by the user. The power on instruction, in one embodiment, may be the user pressing a power switch of the set top box.

In block S302, the selecting module 120 sends a connecting request to the default configuration server 200. Referring to FIG. 3, for example, the configuration server 200a is selected as the default server when the set top box 100 is set for the first time. The IP address of the configuration server 200a may be 10.132.8.6, for example. The selecting module 120 sends the connecting request to the IP address 10.132.8.6 after the set top box 100 is turned on.

In block S304, the selecting module 120 determines if the default configuration server 200a can be successfully connected if an acknowledgement message has been received by the default configuration server 200a. If so, block S318 is executed. Otherwise, block S306 is executed.

In block S306, the selecting module 120 selects another configuration server 200 from the configuration server list cache 110. For example, the selecting module 120 selects the configuration server 200b from the configuration server list cache 110 if the set top box 100 does not receive the acknowledgement message from the default configuration server 200a, and subsequently attempts to connect with the configuration server 200b.

In block S308, the selecting module 120 sends a connecting request to the configuration server 200b.

In block S310, the selecting module 120 determines if the acknowledgement message has been received from the configuration server 200b. If the selecting module 120 receives the acknowledgement message, block S312 is executed. If the selecting module 120 does not receive the acknowledgement message, the process returns to block S306.

In block S312, the obtaining module 130 sends a parameter setting request to the configuration server 200b.

In block S314, the obtaining module 130 receives a parameter setting message from the configuration server 200b.

In block S316, the setting module 140 sets the parameter setting message to the set top box 100.

In block S318, the obtaining module 130 sends a parameter setting request to the default configuration server 200a.

In block S320, the obtaining module 130 receives a parameter setting message from the default configuration server 200a.

In the present disclosure, the set top box 100 can automatically update the software and the system, thereby decreasing operating costs. When the configuration server 200 providing service for the set top box 100 becomes dysfunctional (e.g., does not respond), the selecting module 120 can select another configuration server 200 from the configuration server list cache 110 to take over and provide service for the set top box 100.

The description of the present disclosure has been presented for purposes of illustration and description, and is not intended to be exhaustive or limit to the disclosure in the form disclosed. Many modifications and variations will be apparent to those of ordinary skill in the art. Various inventive embodiments were chosen and described in order to best explain the principles of the present disclosure, the practical application, and to enable others of ordinary skill in the art to understand the present disclosure for various embodiments with various modifications as are suited to the particular use contemplated.

What is claimed is:

1. A set top box for communicating with a plurality of configuration servers for obtaining setting parameters from the configuration servers, the set top box comprising:
a configuration server list cache for storing a list of internet protocol (IP) addresses of the plurality of configuration servers onto a memory system of the set top box;
a selecting module configured for selecting one IP address from the list of the IP addresses;
an obtaining module configured for sending a parameter setting request to one configuration server corresponding to the selected IP address and obtaining a parameter setting message from said configuration server, wherein the one configuration server is selected from the plurality of configuration severs; and
a setting module configured for setting the set top box according to the parameter setting message.

2. The set top box as claimed in claim 1, further comprising an instruction receiving module for receiving a power on instruction.

3. The set top box as claimed in claim 2, wherein the configuration server list cache further stores an IP address of a default configuration server.

4. The set top box as claimed in claim 3, wherein the selecting module is configured for selecting the IP address of the default configuration server according to the power on instruction.

5. The set top box as claimed in claim 4, wherein the selecting module is further configured for sending a connecting request to the default configuration server, and checking if an acknowledgement message corresponding to the connection request has been received from the default configuration server for determining if the default configuration server has been successfully connected.

6. The set top box as claimed in claim 5, wherein the selecting module is further configured for communicating with the default configuration server if the default configuration server is successfully connected.

7. The set top box as claimed in claim 1, wherein the memory system comprises a hard disk drive, a flash memory, a compact disc (CD), or a random access memory.

8. A method for setting parameters for a set top box for communication with a television system, the method comprising:
providing a configuration server list cache for storing internet protocol (IP) addresses of at least one configuration server;
selecting an IP address of a configuration server from the configuration server list cache;
sending a parameter setting request to the selected configuration server;
receiving a parameter setting message from the selected configuration server; and
setting the set top box according to the parameter setting message.

9. The method as claimed in claim 8, further comprising:
receiving a power on instruction; and
selecting an IP address of a configuration server from the configuration server list cache.

10. The method as claimed in claim 9, wherein the configuration server list cache comprises an IP address of a default configuration server.

11. The method as claimed in claim 10, wherein the block of selecting an IP address of a configuration server from the configuration server list cache comprises:
sending a connecting request to the IP address of the default configuration server;
determining if a response has been received from the default configuration server;
selecting another configuration server from the configuration server list cache if the response has not been received from the default configuration server;
sending the connecting request to the other configuration server;
determining if a response has been received from the other configuration server; and
selecting the other configuration server if an acknowledgement message has been received from the other configuration server.

12. The method as claimed in claim 11, further comprising:
selecting the default configuration server if an acknowledgement message has been received from the default configuration server.
